(19) United States
(12) Patent Application Publication
(10) Pub. No.: US 2009/0139823 A1
(43) Pub. Date: Jun. 4, 2009

(54) Handlebar clutch-lever assist

(76) Inventor: Alden Joseph Dyer, Portland, ME (US)

Correspondence Address: BOHAN MATHERS, PO BOX 17707, PORTLAND, ME, 04112-8707, US

(21) Appl. No.: 11/947,287

(22) Filed: Nov. 29, 2007

(51) Int. Cl. F16D 23/12; B62K 23/06

(52) U.S. Cl. 192/114 R

(57) ABSTRACT

Clutch lever assist for capturing and holding a motorcycle clutch lever in its clutch-disengaged position. The assist mounts on the handlebar and has a catch that pivots between a capture position and a release position. The motorcycle operator pulls the clutch lever in toward the clutch-disengaged position and uses a finger or thumb to urge the catch to its capture position. Once the clutch lever is captured, the operator may relax his grip. The catch will hold the clutch in its clutch-disengaged position. Pulling the clutch lever in toward the handlebar slightly, beyond the capture portion of the catch, releases the catch, which is spring-biased and automatically springs back to its release position. The clutch lever is now under operator control. A safety lock is provided optionally on the clutch lever assist, to lock the catch into the clutch-lever engaging position.

### BACKGROUND INFORMATION

1. Field of the Invention

The invention relates to the field of motorcycles and other two-wheeled motor vehicles having handlebars. More particularly, the invention relates to hand-actuated devices on the handlebars of a motorcycle. More particularly yet, the invention relates to a restraining device for a clutch lever.

2. Description of the Prior Art

Motorcycle drivers manually pull a clutch lever in toward the handlebars to disengage a clutch. The clutch lever is biased to a clutch-engaging position, and a significant amount of force must be exerted to pull the lever in far enough to disengage the clutch. During normal driving, when shifting gears, engaging and disengaging the clutch lever is an operation that is executed rather quickly and, thus, does not generally cause undue strain on the motorcycle operator's hand. The situation is different, however, when the operator has to stop travel for a brief period, during which time the operator may opt to hold the clutch lever in, rather than finding neutral and releasing the clutch lever. The reason for this is that it can be difficult to find neutral, particularly on older motorcycles. Neutral is located between first and second gear and, unlike shifting in a car, in which the operator can shift into neutral from any gear, on a motorcycle the operator has to shift sequentially down through the gears to get to neutral. For example, if a motorcycle is moving along a highway in fifth gear, and the operator must stop at a toll booth, he or she shifts down through all the gears, until reaching neutral. The physical spacing between gears is very close, and particularly close between the first and second gears. Typically, the distance between first and second gears is only one-half the physical distance between any other two gears. So, when shifting down, it is very easy to inadvertently click or step through neutral. Newer model motorcycles are equipped with a light that indicates when the transmission is in neutral. With older model motorcycles, the operator typically tries to test whether it is in neutral, while the bike is still rolling. Frequently, motorcycle operators simply hold the clutch lever in the clutch-disengaging position when stopping for a brief period of time, for example, when stopping at a toll booth or in traffic, or when participating in a parade. Since the clutch is wetted with oil, this “riding the clutch” is not detrimental to the clutch, as it is with automobiles.

Holding the clutch lever for more than just a few seconds causes fatigue and sore muscles in the hand, because of the force that must be constantly exerted against the clutch lever spring. Furthermore, the clutch lever is typically mounted on the left handlebar and, thus, it is the left hand that is used to operate the clutch lever. Highway toll booths are, however, on the left side of the lane, which means that the operator has to use the right hand to hand the toll to the collector or throw it into the coin basket, if he can't find neutral quickly enough.

What is needed, therefore, is a device that will hold the clutch lever in its clutch-disengaged position, so as to free up the left hand of the operator. What is further needed is such a device that is easily and quickly engaged and released. What is yet further needed is such a device that is inexpensive, and easy to retrofit on existing motorcycles.

### BRIEF SUMMARY OF THE INVENTION

The invention is a clutch lever assist that is mounted on the handlebar of a motorcycle. The clutch lever assist has a handlebar mount and a catch or finger that is pivotally assembled on a pivot pin on the handlebar mount. The catch is spring-biased to spring to a release position. The intended use of the clutch lever assist is to hold a clutch lever on a motorcycle handlebar in its clutch-disengaged position, in order to relieve the operator from the strain of having to hold the clutch lever for any extended period of time. To use the clutch lever assist, the motorcycle operator pulls the clutch lever toward the handlebar to a position that disengages the clutch. With the lever in this position, the operator uses the thumb to lift the non-operative end of the catch or uses a finger to push the operative end down toward the clutch lever. The operative end of the catch has a hook shape, which captures the lever, holding it in the clutch-disengaged position. Moving the clutch lever slightly toward the handlebar beyond the hook portion of the catch quickly and automatically releases the catch, which springs automatically back to its release position and leaves the clutch lever under the hand control of the operator.

Optionally, a safety lock may be incorporated into the clutch lever assist. The safety lock has a pin that the operator rotates between a lock position and an unlock position. When in the lock position, the safety pin prevents the non-operative end of the catch from dropping back to its spring-biased position. This effectively prevents the catch from being inadvertently released from the clutch lever.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a side view of a first embodiment of the clutch lever assist according to the invention, showing the clutch lever assist mounted on a handlebar and holding the clutch lever in the clutch-disengaged position.

FIG. 2 is a side view of the clutch lever assist in its release position, showing the mounting bolts and biasing spring.

FIG. 3 is a perspective view of the clutch lever assist, showing the pivot bolt and the opening for the setscrew.

FIG. 4 is a perspective view of a second embodiment of the clutch lever assist according to the invention, which is counterweighted.

FIG. 5 illustrates a safety lock for locking the catch into a clutch-lever disengaged position.

FIG. 6 is a cross-sectional view, illustrating the safety lock in its lock position.

FIG. 7 is a cross-sectional view, illustrating the safety lock in its unlock position.

FIG. 8 is a side elevational view of the safety pin.

FIG. 9 is a cross-sectional view of the safety pin, showing that it is a round bar with a recess.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

FIG. 1 shows a preferred embodiment of a clutch lever assist 100 according to the invention, comprising a handlebar mount 140 and a pivotally mounted catch 120. The catch 120 is pivotable between a capture position, in which it engages and holds an actuation lever in a force position, and a release position, in which it is unengaged. The clutch lever assist 100 is shown mounted on a handlebar HB and in the capture position, holding an actuation lever, such as a clutch lever CL, in a clutch-disengaged position. The handlebar HB and clutch lever CL are shown in cross-sectional view only.

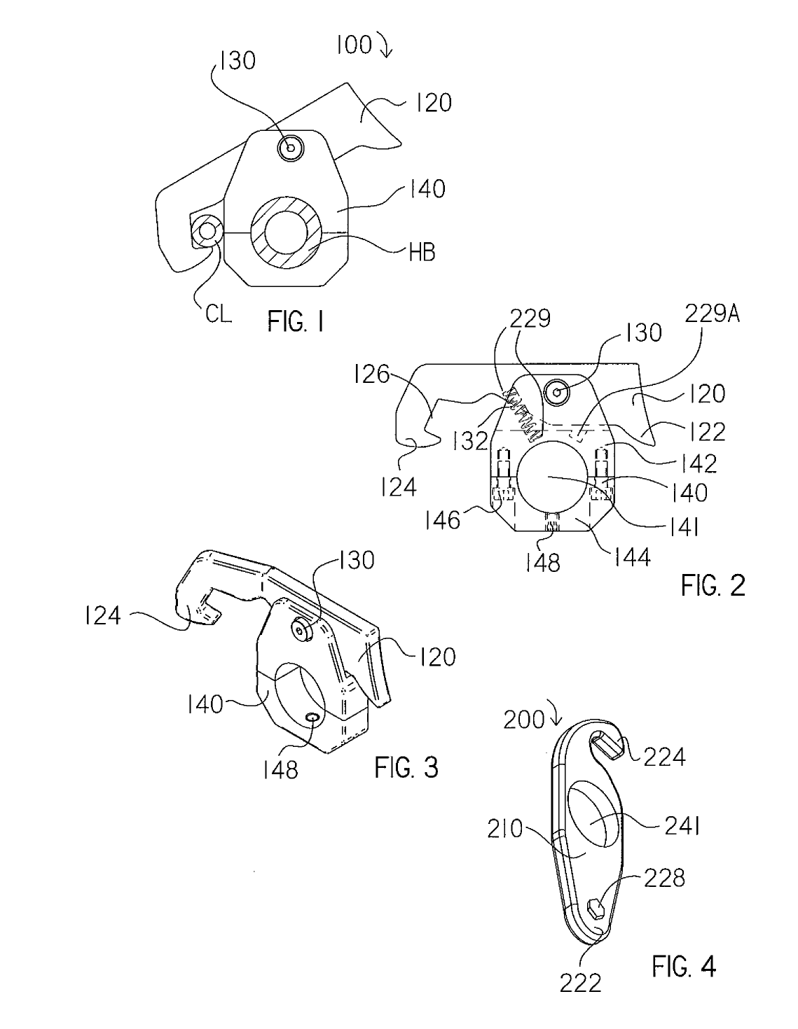

FIGS. 2 and 3 show details of the components of the preferred embodiment of the clutch lever assist 100. The handlebar mount 140 has an upper mount 142 and a lower mount 144, which together form a handlebar-recess 141. Threaded fasteners 146 are used to fasten the two parts together around the handlebar HB. A set screw 148 is used to position and tighten the mount 140 to the handlebar HB, to as to hold the clutch lever assist 100 in a desired position. The catch 120 is pivotally mounted on a pivot pin or bolt 130 in the mount 140. A biasing spring 132 fastened at one end to the mount 140 and at the other end to the catch 120 biases the catch 120 to the release position, as shown in FIG. 2. There are many conventional methods of attaching the biasing spring 132 to the catch 120 and the mount 140. A simple and effective method is to capture each end of the spring 132 in recesses 229 provided on each component.

The catch 120 has a first end 124 that is shaped to form a hook and recess 126, so as to capture and restrain the clutch lever CL when in the capture position shown in FIG. 1. The catch 120 is constructed to facilitate capturing the catch lever CL with a minimum of effort. In the embodiment shown, the second end 122 is constructed to allow the operator to either push against the end 122 with a thumb, or place a finger or thumb under it and lift. Alternatively, the operator may use a finger to push the first end 124 down toward the capture position. Pushing the catch 120 against the spring bias lowers the first end 124 of the catch 120. If the clutch lever CL has been pulled in toward the handlebar HB, moving the catch 120 to the capture position will allow the first end 124 to capture the clutch lever CL. Once captured, the operator may relax his or her grip on the catch 120. The two forces being exerted on the catch 120, i.e., the force exerted by the clutch lever CL against the first end 124 and the upward force exerted by the biasing spring 132, cooperate to securely hold the clutch lever CL captured in the clutch lever assist 100.

Releasing the clutch lever CL from the clutch lever assist 100 merely entails pulling the clutch lever CL in toward the handlebar HB. As can be envisioned from the illustration in FIG. 1, a slight displacement of the clutch lever CL in toward the handlebar HB removes the clutch lever from the constraints of the first end 124 of the catch 120. The catch 120 is then free to swing back to its release position and the clutch lever CL free to swing out to its clutch-engaging position.

An additional recess 229A facing in an opposite direction may also be provided on the upper mount 142, in order to accommodate the various models and configurations of handlebar setups and grips on motorcycles. For example, some motorcyclists prefer larger, cushioned grips. In order to accommodate the larger dimensions of the cushioned grip, the mounting for the clutch lever is readjusted, to move the clutch lever CL out farther from the handlebar, to accommodate the larger handgrip. The standard setup for the clutch lever assist 100 may not work effectively in this case, because the catch 120 may not be not long enough to capture the clutch lever CL. Either the additional recess 229A or the pivot pin 130 for mounting the catch 120 is offset from the center of the mount 140. In the embodiment shown, the pivot pin 130 is offset from the center. Reversing the mount 140 and using this additional recess 229A for mounting the catch 120 moves the catch 120 out farther past the handlebar HB, so that the catch 120 is now able to capture the readjusted clutch lever CL.

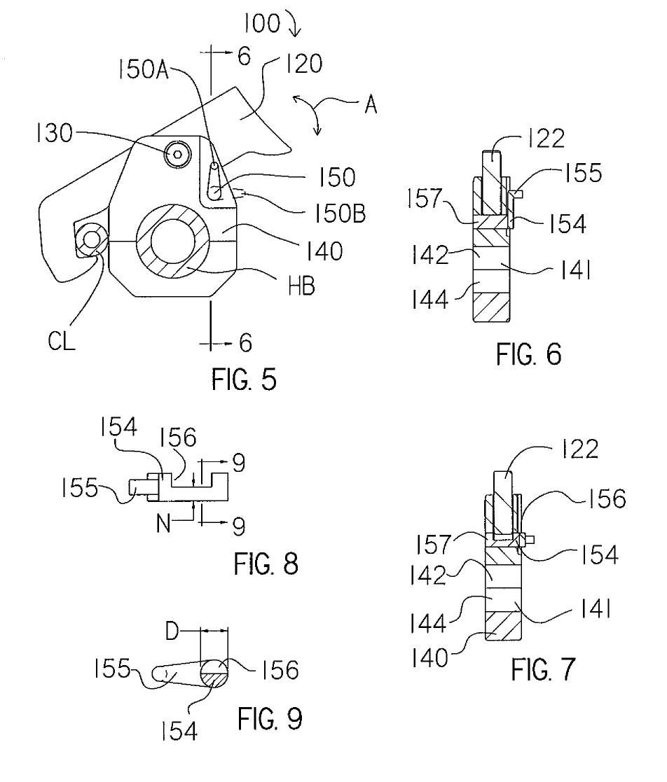

FIGS. 5-9 illustrate a safety lock 150 that may be incorporated into the clutch lever assist 100 as an optional device, to secure the catch 120 in its capture position. It may be desirable for certain maneuvers that require that the clutch be held disengaged to be able to lock the catch 120 in the capture position. For example, the operator may want to get on or off the bike, while the engine is running and use the handlebar HB as leverage. Or a police officer may want to get off the motorcycle in a hurry, yet leave it running, with the clutch lever secured in the clutch-disengaged position. In such cases, it would be hazardous, if the operator were to inadvertently bump or squeeze the clutch lever CL while the catch 120 was in the capture position, because this would cause the catch 120 to automatically release and move toward the release position. The safety lock 150 allows the operator to secure the catch 120 in the clutch-lever engaging position, so that it cannot be inadvertently released, even if the clutch lever CL is squeezed.

The safety lock 150 comprises a safety pin 154 that is inserted into a safety-pin aperture 157 on the upper mount 142. The safety pin 154 is essentially a round pin with a recess 156 formed in a central section of the pin. An actuating tab 155 is provided on one end of the safety pin 154 for manipulating the safety lock 150. See FIGS. 8 and 9. The cross-sectional views in FIGS. 6 and 7 illustrate how the safety pin 154 is rotated to shift the safety lock 150 between a lock position and an unlock position, respectively. Arrow A indicates the direction of rotation. When in the lock position, the safety pin 154 is rotated such, that a wide dimension D of the safety pin (shown in FIG. 9) is in a vertical position. This prevents the second end 122 of the catch 120 from moving downward and holds the first end 124 in the capture position. Thus, if the motorcycle operator were to bump the clutch lever CL, so that the catch 120 would normally automatically release, the safety lock 150 will prevent the release. When in the unlock position, the safety pin 154 is rotated until a narrow dimension N is in a vertical position. This allows the non-operative or second end 122 of the catch 120 to move farther down and release the operative or first end 124 from the clutch lever CL.

FIG. 4 illustrates a second embodiment of a clutch lever assist 200 according to the invention. The clutch lever assist 200 is a single component body 210 having a handlebar recess 241 for mounting on a handlebar, a first end 224, and a second end 222. The handlebar recess 241 fits over the handlebar HB with sufficient play to allow the clutch lever assist 200 to rotate easily about the handlebar. In the embodiment shown, the single component body 210 is placed on the handlebar HB by first removing the hand grip from the handlebar and slipping the single component body 210 onto the handlebar HB into the desired location. The first end 224 is similar in shape and function to the first end 124 of the first embodiment, in that it is shaped like a hook 224 to form a clutch lever recess 226 for capturing the clutch lever CL. The second end 222 has a counterweight 228 that serves to bias the first end 224 to a release position. In the embodiment shown, the counterweight 228 is a threaded bolt inserted through a bore that is provided on the second end 222 and secured on the opposite face of the body with a nut. It is understood, however, that there are numerous ways to mount a counterweight on the clutch lever assist 200. To engage the clutch lever CL, the operator merely moves the first end 224 down toward the clutch lever CL. Once the clutch lever CL is captured in the clutch lever recess 226, the spring force of the clutch lever and the counterweight 228 cooperate to securely hold the catch lever CL within the hook 224. As with the first embodiment, pulling the clutch lever CL slightly toward the handlebar HB releases the clutch lever CL from the clutch lever assist 200, which automatically rotates to is release position, in which the first end 224 is raised above the plane of the clutch lever CL.

It is understood that the embodiments described herein are merely illustrative of the present invention. Variations in the construction of the clutch lever assist may be contemplated by one skilled in the art without limiting the intended scope of the invention herein disclosed and as defined by the following claims.

What is claimed is:

1. Device for holding a handlebar lever in a forced position, said device comprising:
a handlebar mount adapted for mounting on a handlebar of a vehicle having a lever-actuated mechanism and a lever mounted on said handlebar for actuating said mechanism; and
a catch pivotably assembled on said handlebar mount for selectively pivoting said catch between a lever-engaging position and a lever-disengaging position.

2. The device of claim 1 further comprising a biasing spring that is mounted at a first spring end to said catch and at a second spring end to said handlebar mount, wherein said biasing spring biases said catch toward a lever-disengaging position.

3. The device of claim 1, wherein said catch has a first end with a hook for engaging said lever, and wherein, once said catch is placed in said lever-engaging position, said catch and said lever cooperate to hold said catch in a lever-engaging position without applying additional force.

4. The device of claim 1, wherein said handlebar mount has an upper mount and a lower mount, which together form a handlebar recess, and wherein said upper mount and said lower mount are adapted to fasten together about said handlebar.

5. The device of claim 4, wherein said catch is pivotably mounted on said upper mount.

6. The device of claim 1, further comprising a safety lock that is movable between a lock position, in which said catch is held in said lever-engaging position and prevented from moving into said lever-disengaging position, and an unlock position, in which said catch is free to move away from said lever-engaging position.

7. The device of claim 6, said safety lock including a safety pin and an actuating lever connected to said safety pin, wherein said handlebar mount has a bore for receiving said safety pin, and wherein said safety pin is rotatable in said bore by means of said actuating lever between said lock position and said unlock position.

8. Device for holding a handlebar lever in a forced position, said device comprising a unitary body that includes a handlebar mount and a catch, wherein said handlebar mount has a bore that is dimensioned to slide onto said handlebar from an end of the handlebar and remain rotatable about said handlebar. such that said catch is rotatable between a lever-engaging position and a lever-disengaging position.

9. The device of claim 8 further comprising a counterweight for biasing said catch to said lever-disengaging position.

10. The device of claim 9, wherein said unitary body has a first end and a second end and wherein said catch is formed on said first end of said unitary body and said counterweight is mounted on said second end.

11. The device of claim 10, wherein said unitary body has an aperture on said second end and said counterweight is a pin that is inserted into said aperture.
